(19) United States
(12) Patent Application Publication
(10) Pub. No.: US 2017/0123466 A1
(43) Pub. Date: May 4, 2017

(54) System Management Device with High-Powered Power Over Ethernet

(71) Applicant: Thomas Craig Carnevale, Plainfield, IL (US)

(72) Inventor: Thomas Craig Carnevale, Plainfield, IL (US)

(21) Appl. No.: 15/341,976

(22) Filed: Nov. 2, 2016

Related U.S. Application Data
(60) Provisional application No. 62/249,451, filed on Nov. 2, 2015.
(60) Provisional application No. 62/249,454, filed on Nov. 2, 2015.

(51) Int. Cl. G06F 1/18; G06F 13/16; G06F 13/40; H01R 24/64

(52) U.S. Cl. CPC G06F 1/189; G06F 1/187; G06F 1/181; H01R 24/64; G06F 13/1668; G06F 13/4022; H01R 2107/00

(57) ABSTRACT

A system management device with high-powered power over Ethernet (PoE) connects PoE devices to a central processing unit via a plurality of networking ports. The central processing unit is configured to receive an input data stream, send an output data stream, and regulate a current flow through each of the networking ports. Data retrieved from the connected PoE devices, program files, and other data can be stored on at least one data storage device; the central processing unit being electronically connected to the data storage device. Each of the networking ports is mounted into a housing that stores the central processing unit and the data storage device. A plurality of indicator lights is mounted into the housing opposite the networking ports; a specific indicator light from the indicator lights corresponding to a specific port from the networking ports; the specific indicator light showing the power state of the specific port.

The current application claims a priority to the U.S. Provisional Patent application Ser. No. 62/249,454 filed on Nov. 2, 2015.

### FIELD OF THE INVENTION

The present invention relates generally to networking equipment. More specifically, the present invention is a system management device with high-powered power over Ethernet (PoE) that provides the capabilities of a server and a PoE switch in a single unit.

### BACKGROUND OF THE INVENTION

Network Video Recorders (NVRs) are commonly used to power and control Internet Protocol (IP) network surveillance cameras. Often, the systems used for these cameras require the user to buy multiple devices to properly control and power the cameras, and record and store the videos or pictures that they capture. Additionally, more sophisticated cameras tend to require larger amounts of power to operate.

Accordingly, there is a present need for an NVR which is capable of powering and controlling various sophisticated cameras without the need for additional devices. The present invention is a high-powered Power over Ethernet (PoE) switch embedded into a server, designed for use with IP network surveillance cameras. It produces much higher power than the traditional switch, which allows users to connect more cameras, as well as more cameras that require higher power draws (such as a dome pan-tilt-zoom camera).

The present invention is an ecosystem-driven appliance that combines a server and network switch in one product. It allows for flexible video management software options as well as versatile storage selection such as network-attached storage (NAS), Redundant Array of Independent Disks (RAID) storage, or any other third-party storage system. While IP video has struggled to replicate the plug-and-play legacy that was created by analog systems, the present invention brings that ease of use one step closer to the integrator and the end-user alike. Designed for entry-level systems, or enterprise-class deployments, the present invention provides a scalable solution regardless of project size. All systems come with solid state drives, securing the operating system for reliability; Intel processors ensuring speed and security; and high wattage PoE ports to allow for all camera types from Panoramic 360/180, PTZ, and Ultra HD surveillance cameras.

### BRIEF DESCRIPTION OF THE DRAWINGS

FIG. 1 is a perspective view of the present invention in a first embodiment, wherein the plurality of networking ports is specifically 8 ports.

FIG. 2 is a front elevational view of the present invention in the first embodiment, wherein a specific indicator light is identified.

FIG. 3 is a rear elevational view of the present invention in the first embodiment, wherein the specific port corresponding to the specific indicator light is identified.

FIG. 4 is a front elevational view of the present invention, wherein the mounting bracket is adjacently connected to the base plate.

FIG. 5 is a perspective view of the present invention in a second embodiment, wherein the plurality of networking ports is specifically 24 ports.

FIG. 6 is a front elevational view of the present invention in the second embodiment, wherein a specific indicator light is identified.

FIG. 7 is a rear elevational view of the present invention in the second embodiment, wherein the specific port corresponding to the specific indicator light is identified.

FIG. 8 is a front elevational view of the present invention, wherein the mounting bracket is adjacently connected to the lateral wall.

FIG. 9 is a diagram depicting the electronic connections between the central processing unit and the other electronic components of the present invention.

### DETAIL DESCRIPTIONS OF THE INVENTION

All illustrations of the drawings are for the purpose of describing selected versions of the present invention and are not intended to limit the scope of the present invention.

The present invention is a system management device with high-powered power over Ethernet (PoE). The present invention provides the capabilities of a server and a high-powered PoE switch in a single unit. The single unit design eliminates the need for users to purchase multiple devices and increases overall ease of use and management of a network system. While the present invention is hereinafter described as a network video recorder (NVR) for use with Video Management Software (VMS) and Internet Protocol (IP) network surveillance cameras, it is to be known that the present invention can be applied to any other network management system.

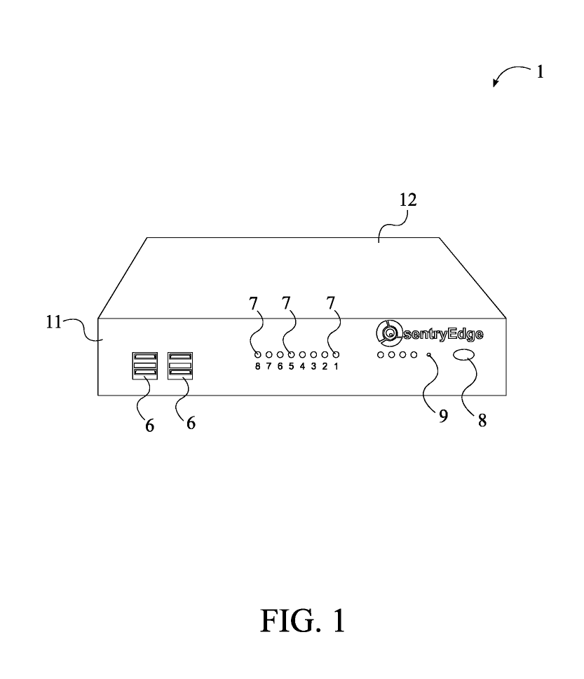

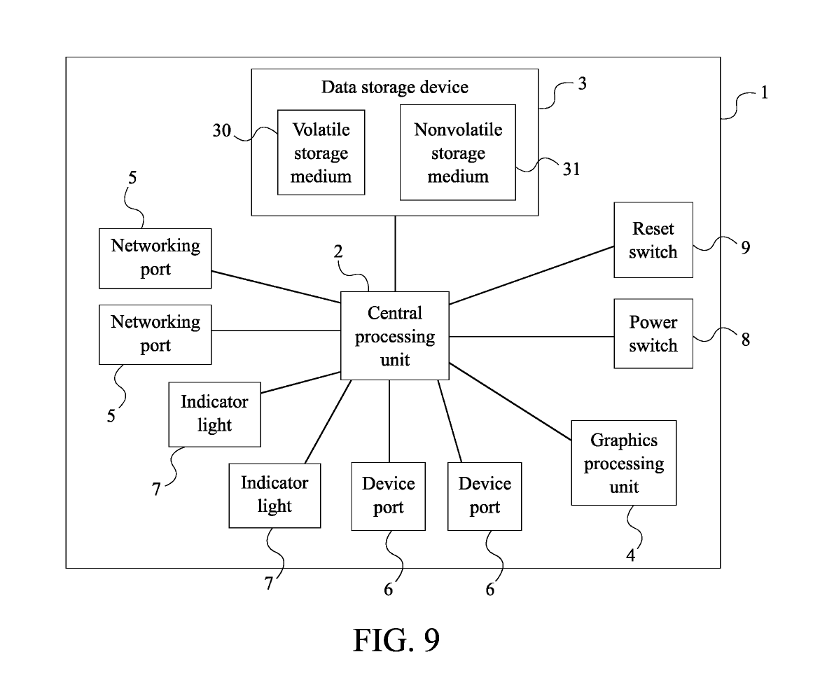

In reference to FIG. 1 and FIG. 9, the present invention comprises a housing 1, a central processing unit 2, at least one data storage device 3, a graphics processing unit 4, a plurality of networking ports 5, a plurality of device ports 6, a plurality of indicator lights 7, a power switch 8, and a reset switch 9. The housing 1 is a containment unit that supports and protects the other components of the present invention. In the preferred embodiment of the present invention, the housing 1 is constructed from metal, however, any other rigid material may be used as an alternative in constructing the housing 1. Furthermore, in the preferred embodiment, the housing 1 is rectangular in shape, however, the housing 1 may be configured in any other shape in other embodiments of the present invention.

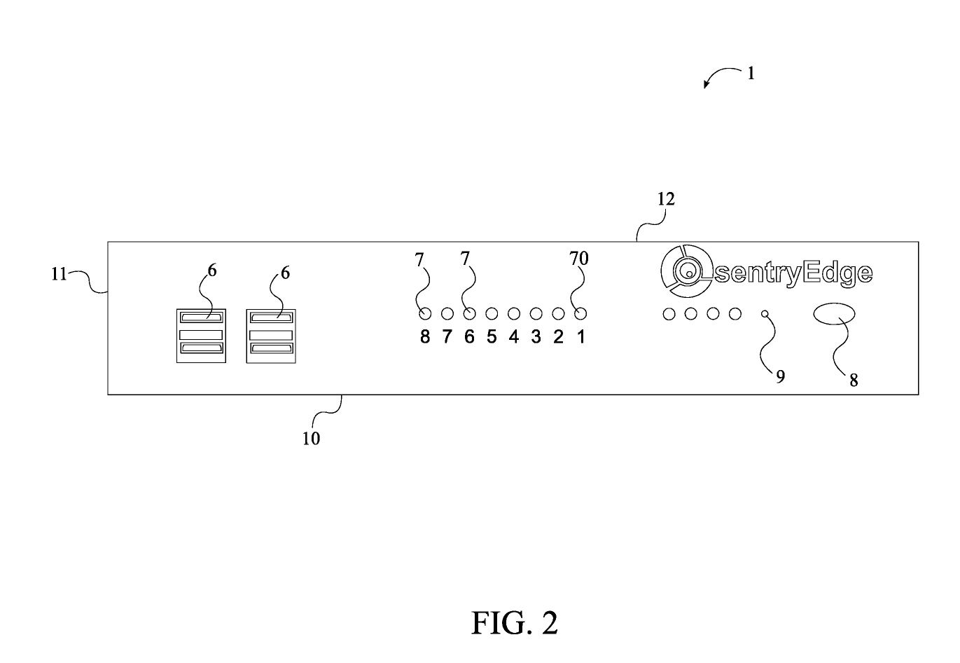

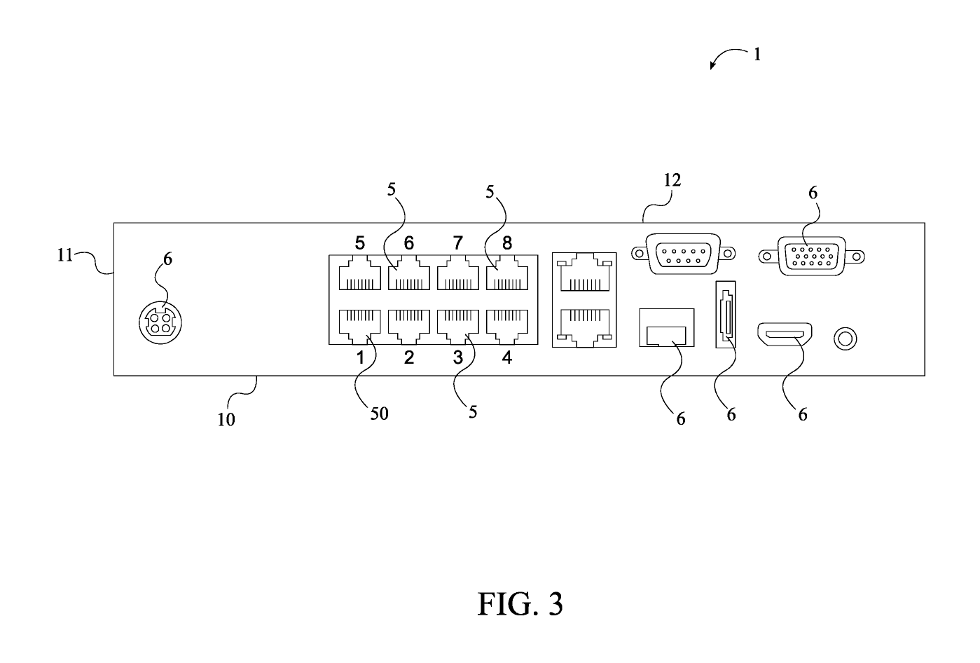

In reference to FIGS. 2-3, the housing 1 comprises a base plate 10, a lateral wall 11, and a top plate 12; the base plate 10 and the top plate 12 being positioned opposite each other about the lateral wall 11. In the preferred embodiment, the base plate 10 is flat, allowing the housing 1 to be stored and used on a flat surface. The housing 1 can also be configured to be mounted on a rack, or similar structure. As such, the present invention may further comprise a mounting bracket 13. The mounting bracket 13 is adjacently connected to the housing 1, and provides a secure connection between the housing 1 and the rack, or other mounting structure.

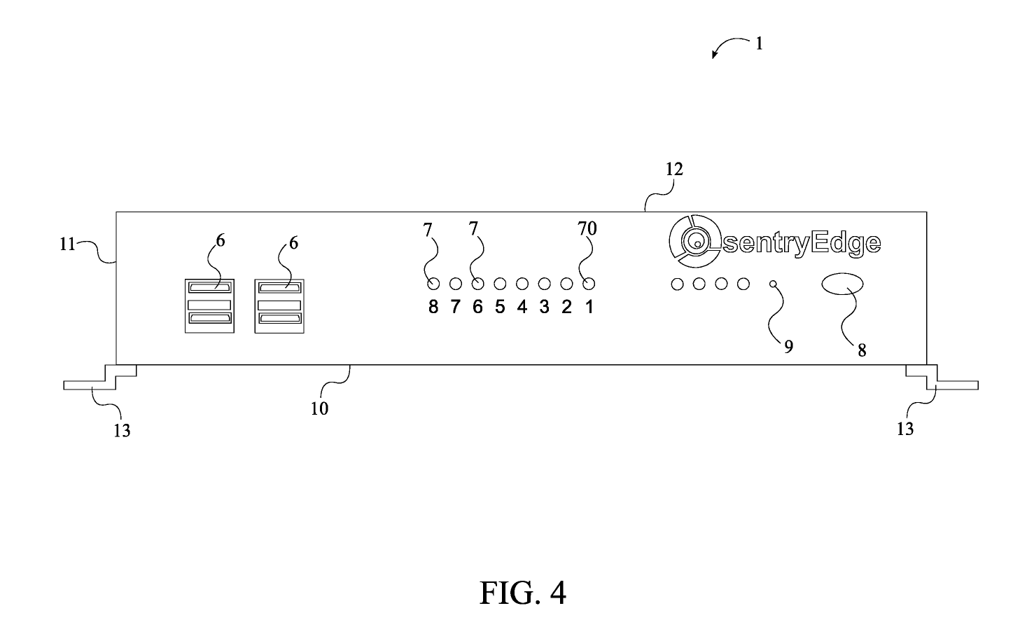

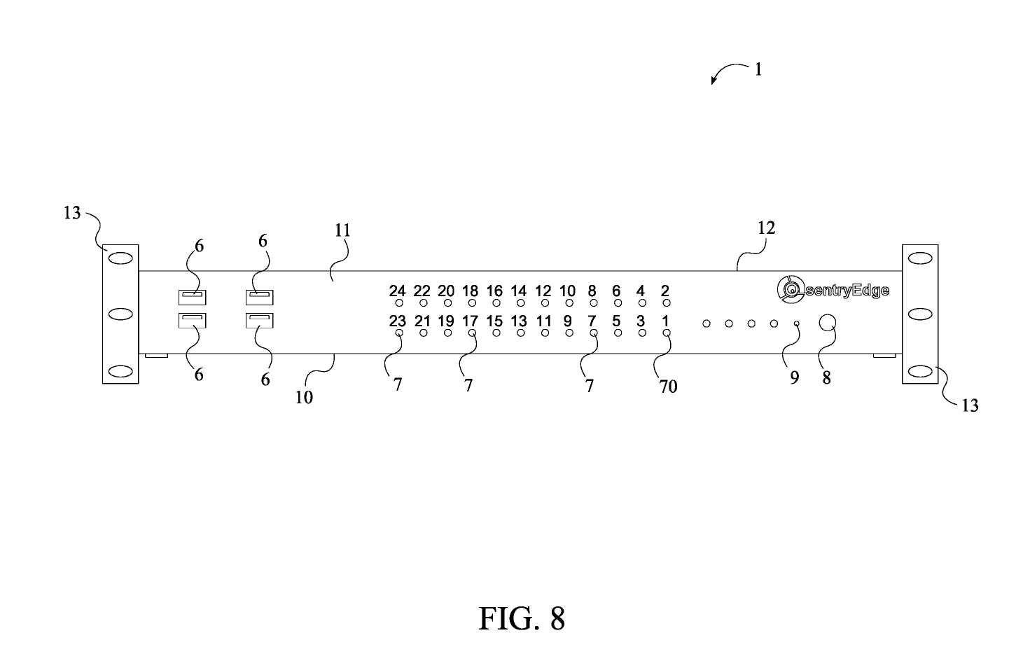

In reference to FIG. 4, in one embodiment, the mounting plate is connected to the base plate 10, wherein screws positioned into the base plate 10 are first removed. The mounting bracket 13 is then aligned with the screw holes and the screws are re-installed to secure the mounting bracket 13 in place about the housing 1. In reference to FIG. 8, in another embodiment, the mounting bracket 13 has a first bracket and a second bracket, wherein the mounting bracket 13 is connected to the lateral wall 11. The first bracket and the second bracket are connected to opposite sides of the lateral wall 11, allowing the housing 1 to be mounted to a rack, or other mounting structure.

The central processing unit 2, the at least one storage device, and the graphics processing unit 4 are positioned and mounted within the housing 1 as depicted in FIG. 9. The central processing unit 2 provides the electronic circuitry required to carry out computer program instructions by performing arithmetic, logical, control, and input/output operations. In the preferred embodiment of the present invention, the central processing unit 2 is an integrated circuit that has multiple cores used to maximize processing power. The central processing unit 2 may be a dual core processor, quad core processor, or have any other number of cores. The central processing unit 2 communicates with other components and manages the flow of information throughout the system. As such, the central processing unit 2 is electronically connected to the at least one data storage device 3, the graphics processing unit 4, the plurality of networking ports 5, the plurality of device ports 6, and the plurality of indicator lights 7.

The at least one data storage device 3 allows the present invention to store information, wherein the information is accessible to the central processing unit 2. In reference to FIG. 9, in the preferred embodiment of the present invention, the at least one data storage device 3 includes at least one volatile storage medium 30 and at least one nonvolatile storage medium 31. This allows the central processing unit 2 to quickly store and access information that is actively being used via the at least one volatile storage medium 30, while also providing the ability to store large amounts of information via the at least one nonvolatile storage medium 31.

In one embodiment, each of the at least one volatile storage medium 30 is a memory chip configured to provide random-access memory (RAM) to the central processing unit 2. RAM allows the central processing unit 2 to quickly store and access information that is actively being used. This allows programs and applications to run quickly and efficiently using the present invention. In some embodiments, two 4 gigabyte (GB) RAM memory chips are utilized to provide a total of 8 GB of RAM for the system. However, any number of chips with varying amounts of RAM may be used in alternative embodiments in order to achieve the total desired RAM for the system.

The at least one nonvolatile storage medium 31 is used to store large amounts of data including an operating system of the present invention, recorded videos, and various other programs and files including the VMS used to control and manage the IP network surveillance cameras. The central processing unit 2 is able to access information stored on the at least one nonvolatile storage medium 31 in order to boot the system, view videos recorded using the IP network surveillance cameras, and run or access miscellaneous programs and files.

In one embodiment, each of the at least one nonvolatile storage medium 31 is a solid state drive (SSD). In another embodiment, each of the at least one nonvolatile storage medium 31 is a hard disk drive (HDD). In yet another embodiment, the at least one nonvolatile storage medium 31 provides a combination of SSD and HDD storage. Additionally, the storage size of each of the at least one nonvolatile storage medium 31 may vary between embodiment. In some embodiments, a 1, 2, or 4 terabyte (TB) HDD is used, while in other embodiments a 60 GB SSD is used in conjunction with up to three 2 or 4 TB HDDs.

Furthermore, the arrangement of each of the at least one nonvolatile storage medium 31 may vary from one embodiment to another. In one embodiment, the at least one nonvolatile storage medium 31 is configured as a redundant array of independent disks (RAID). The RAID arrangement of the at least one nonvolatile storage medium 31 allows data to be copied across multiple devices, wherein the central processing unit 2 can access each of the at least one nonvolatile storage medium 31. The RAID configuration is particularly beneficial because the redundant storage of data increases the security of data stored using the at least one nonvolatile storage medium 31 and reduces the chances that data is lost in the event of a failure or malfunction in one of the at least one nonvolatile storage medium 31.

The graphics processing unit 4 communicates with the central processing unit 2 to render images from the data that is stored on the at least one data storage device 3. The graphics processing unit 4 manipulates the data stored on the at least one data storage device 3 to quickly and effectively create images that may be displayed to a user. In the preferred embodiment, the graphics processing unit 4 is configured to render images that are displayed on an external screen connected to one of the plurality of device ports 6. However, in alternative embodiments, a screen may be built into the housing 1 for directly displaying images rendered by the graphics processing unit 4.

The plurality of networking ports 5, the plurality of device ports 6, and the plurality of indicator lights 7 are mounted into the housing 1, such that each is accessible and visible about the exterior of the housing 1. In the preferred embodiment, the plurality of networking ports 5 is designed to connect the IP network surveillance cameras to the present invention, while the plurality of device ports 6 is utilized to connect additional devices, such as a monitor, mouse, keyboard, speakers, headphones, etc. The plurality of indicator lights 7 is utilized to provide a visual display of which devices are being powered by the present invention and which devices are self-powered.

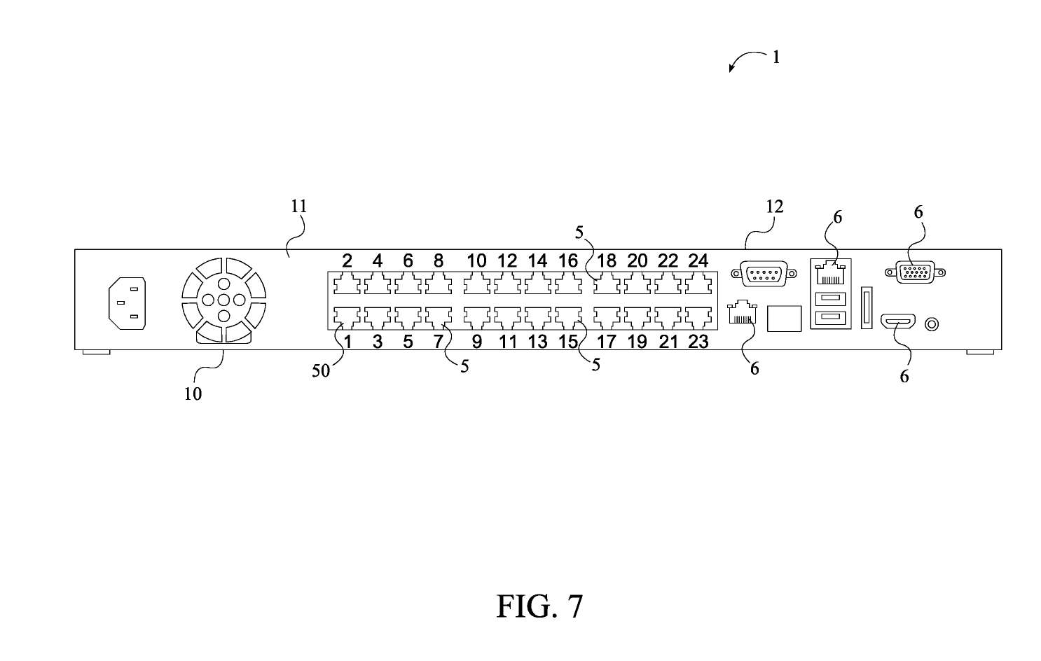

In reference to FIG. 3 and FIG. 7, the plurality of networking ports 5 is mounted into the lateral wall 11 of the housing 1, and is positioned about the back of the housing 1. In the preferred embodiment, each of the plurality of networking ports 5 is a Registered Jack (RJ); more specifically, a RJ-45 Ethernet port that supports the PoE+standard and is capable of delivering up to 25.5 Watts of power to the connected device. Ideally, the plurality of networking ports 5 provides a means for connecting the IP network surveillance cameras to the present invention via Ethernet cables. However, the plurality of networking ports 5 may be utilized to connect any other PoE devices to the present invention via the Ethernet cables.

Each of the plurality of networking ports 5 is electronically connected to the central processing unit 2, wherein the central processing unit 2 is configured to regulate a current flow through each of the plurality of networking ports 5. Through the plurality of networking ports 5, the central processing unit 2 is able to detect whether or not a connected IP network surveillance camera, or other PoE device, requires power. If the central processing unit 2 detects that one or more of the connected devices requires power, then the central processing unit 2 determines the specific amount of power required for each of the plurality of networking ports 5 and regulates the current flow through each of the plurality of networking ports 5 accordingly.

In addition to providing power to connected devices, each of the plurality of networking ports 5 allows data to be transferred from the connected device to the central processing unit 2 and the at least one data storage device 3. As such, the central processing unit 2 is configured to receive an input data stream through each of the plurality of networking ports 5 and send an output data stream through each of the plurality of networking ports 5. The input data stream allows pictures and videos to be recorded from the IP network surveillance cameras onto the at least one data storage device 3, while the output data stream allows the user to control each of the IP network surveillance cameras (e.g. rotate, zoom, etc.) through the present invention.

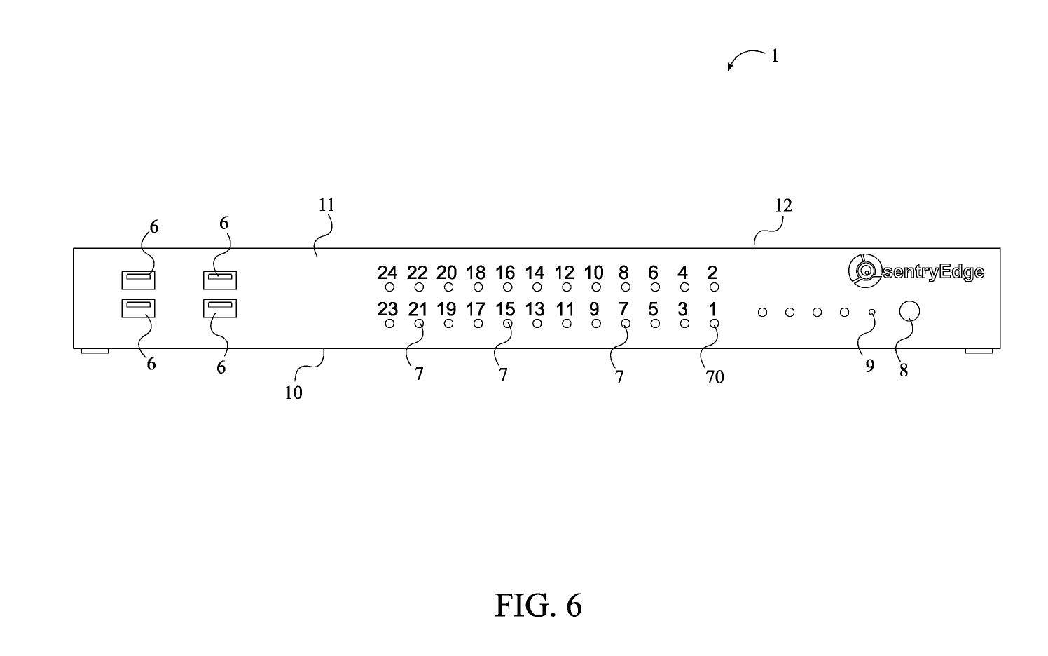

In reference to FIG. 2 and FIG. 6, in the preferred embodiment of the present invention, the plurality of indicator lights 7 is positioned about the housing 1 opposite the plurality of networking ports 5. In this way, the plurality of indicator lights 7 is visible about the front of the housing 1. Furthermore, in the preferred embodiment, each of the plurality of indicator lights 7 is a light emitting diode. However, in other embodiments, a different light source may be utilized for each of the plurality of indicator lights 7. The plurality of indicator lights 7 displays the status of devices connected to the present invention.

When used in conjunction with the plurality of networking ports 5, each of the plurality of indicator lights 7 shows whether each of the connected IP network surveillance cameras is self-powered or is being powered by the present invention. To indicate the power consumption of each of the IP network surveillance cameras, the plurality of networking ports 5 and the plurality of indicator lights 7 are grouped into a plurality of pairs; each of the plurality of pairs including a specific indicator light 70 from the plurality of indicator lights 7 corresponds to a specific port 50 from the plurality of networking ports 5.

Furthermore, the specific indicator light 70 and the specific port 50 of each of the plurality of pairs are labeled with a unique identifier, as depicted in FIGS. 2-3 and FIGS. 6-7. The unique identifier for the specific indicator light 70 is identical to the unique identifier for the specific port 50, such that the specific indicator light 70 is visually associated with the specific port 50; the unique identifier of the specific indicator light 70 being positioned adjacent to specific indicator light 70, and the unique identifier of the specific port 50 being positioned adjacent to the specific port 50. Meanwhile, the unique identifier associated with each of the plurality of pairs is different. For example, the unique identifier for the specific indicator light 70 and the specific port 50 of a first pair from the plurality of pairs is the number 1, while the unique identifier of a second pair from the plurality of pairs is the number 2, and so on.

In reference to FIGS. 2-3 and FIGS. 6-7, each of the plurality of device ports 6 is mounted into the lateral wall 11 of the housing 1; either the front or back of the housing 1 in the preferred embodiment. The plurality of device ports 6 is utilized to connect a range of different devices to the present invention, such as a monitor, mouse, keyboard, speakers, headphones, etc. In order to accommodate the connection types for various devices, the plurality of device ports 6 includes at least one of a Universal Serial Bus (USB) port, an external Serial AT Attachment (eSATA) port, a Video Graphics Array (VGA) port, a High-Definition Multimedia Input (HDMI) port, a RS-232 port, a Wide Area Network (WAN) port, a Local Area Network (LAN) port, or a headphone jack.

In one embodiment of the present invention, the plurality of device ports 6 includes three USB 2.0 ports, two USB 3.0 ports, two eSATA ports, one VGA port, one HDMI port, and one 3.5 mm headphone jack. In another embodiment of the present invention, the plurality of device ports 6 includes four USB 2.0 ports, two USB 3.0 ports, one eSATA port, one RS-232 port, one VGA port, one HDMI port, and one 3.5 mm headphone jack. It is to be understood that the plurality of device ports 6 may utilize any other number or combination or ports in other embodiments of the present invention. The plurality of indicator lights 7 can also be used in conjunction with the plurality of device ports 6 to show that each of the plurality of device ports 6 is functioning properly. For example, a WAN indicator light may be utilized to show connections through the WAN port are active, while a LAN indicator light may be utilized to show connections through the LAN port are active.

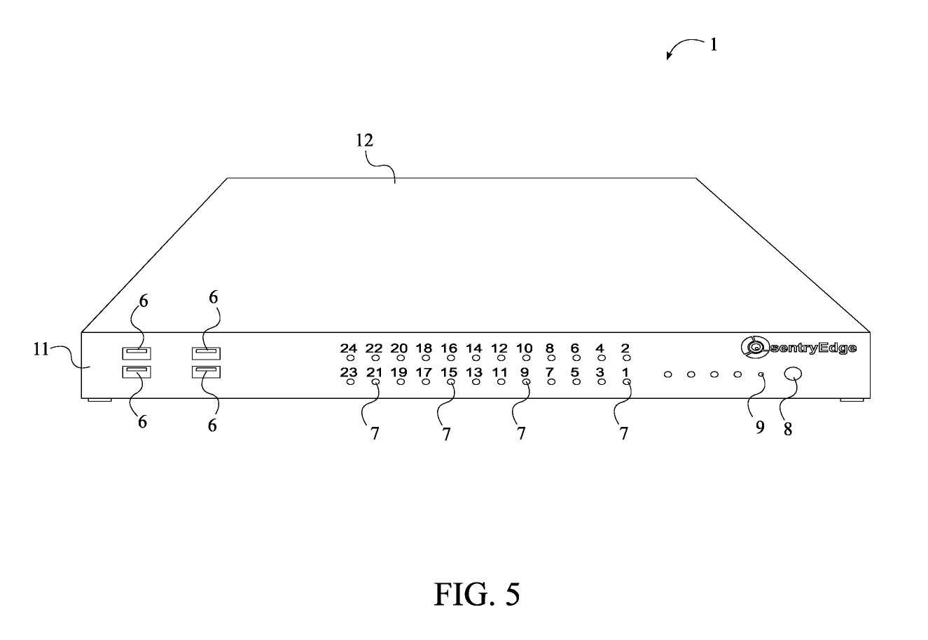

In reference to FIG. 5, the power switch 8 and the reset switch 9 are operably disposed about the housing 1, such that the power switch 8 and the reset switch 9 are readily accessible to the user. Both the power switch 8 and the reset switch 9 are operably connected to the central processing unit 2, wherein the power switch 8 and the reset switch 9 are able to control the power levels of the present invention. The power switch 8 is utilized to toggle the present invention on and off, while the reset switch 9 allows the user to restart the present invention. In some embodiments, the power switch 8 may be illuminated in order to indicate a current power state of the present invention.

Power is supplied to the electronic components of the present invention through a power cord, wherein the power cord can be plugged into the desired power source. The power cord may include a power brick depending on the embodiment of the present invention and the specific power needs. The power requirements of the present invention depends on the specific number of the plurality of networking ports 5 that are being utilized, and the specific type of devices being connected through the plurality of networking ports 5 and the plurality of device ports 6.

Although the invention has been explained in relation to its preferred embodiment, it is to be understood that many other possible modifications and variations can be made without departing from the spirit and scope of the invention as hereinafter claimed.

What is claimed is:

1. A system management device with high-powered power over Ethernet comprises:
a housing;
a central processing unit;
at least one data storage device;
a graphics processing unit;
a plurality of networking ports;
a plurality of device ports;
the central processing unit, the at least one storage device, and the graphics processing unit being mounted within the housing;
the plurality of networking ports and the plurality of device ports being mounted into the housing;
the at least one storage device, the graphics processing unit, the plurality of networking ports, and the plurality of device ports being electronically connected to the central processing unit;
the central processing unit being configured to receive an input data stream through each of the plurality of networking ports;
the central processing unit being configured to send an output data stream through each of the plurality of networking ports; and
the central processing unit being configured to regulate a current flow through each of the plurality of networking ports.

2. The system management device with high-powered power over Ethernet as claimed in claim 1 comprises:
a plurality of power indicator lights;
the plurality of power indicator lights being mounted into the housing; and
the plurality of power indicator lights being electronically connected to the central processing unit.

3. The system management device with high-powered power over Ethernet as claimed in claim 2 comprises:
the plurality of indicator lights being positioned about the housing opposite the plurality of networking ports.

4. The system management device with high-powered power over Ethernet as claimed in claim 2 comprises:
a specific indicator light from the plurality of power indicator light corresponding to a specific port from the plurality of networking ports.

5. The system management device with high-powered power over Ethernet as claimed in claim 1, wherein the at least one data storage device includes at least one volatile storage medium.

6. The system management device with high-powered power over Ethernet as claimed in claim 1, wherein the at least one data storage device includes at least one nonvolatile storage medium.

7. The system management device with high-powered power over Ethernet as claimed in claim 6, wherein the at least one nonvolatile storage medium is configured as a redundant array of independent disks.

8. The system management device with high-powered power over Ethernet as claimed in claim 1 comprises:
a power switch;
the power switch being operably disposed about the housing; and
the power switch being operably connected to the central processing unit.

9. The system management device with high-powered power over Ethernet as claimed in claim 8, wherein the power switch is illuminated.

10. The system management device with high-powered power over Ethernet as claimed in claim 1 comprises:
a reset switch;
the reset switch being operably disposed about the housing; and
the reset switch being operably connected to the central processing unit.

11. The system management device with high-powered power over Ethernet as claimed in claim 1, wherein the plurality of device ports includes at least one of a Universal Serial Bus port, an external Serial AT Attachment port, a Video Graphics Array port, a High-Definition Multimedia Input port, a RS-232 port, a Wide Area Network port, a Local Area Network port, or a headphone jack.

12. The system management device with high-powered power over Ethernet as claimed in claim 1, wherein each of the plurality of networking ports is a RJ-45 Ethernet port.

13. The system management device with high-powered power over Ethernet as claimed in claim 1, wherein each of the plurality of networking ports is configured to deliver up to 25.5 Watts of power.

14. The system management device with high-powered power over Ethernet as claimed in claim 1 comprises:
a mounting bracket; and
the mounting bracket being adjacently connected to the housing.

15. The system management device with high-powered power over Ethernet as claimed in claim 14 comprises:
the mounting bracket being connected to a base plate of the housing.

16. The system management device with high-powered power over Ethernet as claimed in claim 14 comprises:
the mounting bracket being connected to a lateral wall of the housing.

17. The system management device with high-powered power over Ethernet as claimed in claim 1, wherein the housing is configured to be mounted to a rack.
